(19) United States
(12) Patent Application Publication
(10) Pub. No.: US 2009/0070569 A1
(43) Pub. Date: Mar. 12, 2009

(54) BRANCH PREDICTION DEVICE,BRANCH PREDICTION METHOD, AND MICROPROCESSOR

(75) Inventors: Tsuyoshi NAGAO, Kanagawa (JP); Hideki Matsuyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 12/191,071

(22) Filed: Aug. 13, 2008

(30) Foreign Application Priority Data
Sep. 11, 2007 (JP) 2007-235342

(51) Int. Cl. G06F 9/30

(52) U.S. Cl. 712/239; 712/E09.016

(57) ABSTRACT

A branch prediction device predicts a branching probability in which a branch condition of a conditional branch instruction read out from an instruction memory storing an instruction is satisfied. A branch prediction entry part included in the branch prediction device stores prediction information as to whether or not the branch condition of the conditional branch instruction is satisfied. An entry update part included in the branch prediction device predicts the branching probability when the conditional branch instruction is executed next time based on a branch direction and updates the prediction information when the branch condition is satisfied by executing the conditional branch instruction.

### BACKGROUND OF THE INVENTION

1. Field of the Invention

The present invention relates to a branch prediction device, a branch prediction method, and a microprocessor, and more particularly, to a branch prediction device, a branch prediction method, and a microprocessor predicting next branch result based on past branch history information.

2. Description of Related Art

Recently, in most microprocessors, a pipeline processing has been employed to increase a processing speed. The pipeline processing is the processing for having a plurality of processing units mounted within the microprocessor execute a plurality of instructions concurrently and in parallel. In the pipeline processing, each instruction is executed by each processing unit with being shifted from each other at a little at a time so that each processing unit can concurrently and independently operate in synchronization with a clock. Thus each processing unit can operate with high efficiency, which improves the processing speed of the microprocessor.

In order to keep high speed processing by the pipeline processing, each processing unit needs to execute the instructions without stopping. However, the situation known as a hazard may be occurred in which the operation of each processing unit is stopped.

For example, the hazard may be occurred when there is included a conditional branch instruction in the instructions. The conditional branch instruction is the instruction in which a branch is taken only when a certain condition is met. Therefore, it is recognized whether or not the branch is taken only after the processing unit executes the conditional branch instruction, which means the operation of each processing unit needs to be stopped until execution of the conditional branch instruction. Such a hazard is called control hazard.

In order to prevent the processing speed from being reduced due to the control hazard, there is provided a branch prediction device performing the branch prediction in the microprocessor. The branch prediction device predicts whether or not the execution result of the conditional branch instruction indicates the branch taken, or in other words whether or not the branch condition of the conditional branch instruction is satisfied (branching probability). Then the microprocessor speculatively executes the instructions after the conditional branch instruction based on the prediction by the branch prediction device. When the prediction makes a hit, the microprocessor continues the execution. On the other hand, when the prediction makes a miss, the microprocessor discards the processing result which is speculatively executed and re-executes the instructions after the conditional branch instruction.

In a recent microprocessor, the number of pipeline stages is increased in order to increase the operating frequency for enhancing the performance. As the number of pipeline stages increases, the processing speed greatly decreases when the prediction makes a miss. Accordingly, it is one of the important issues to enhance the accuracy of the branch prediction.

In general, the execution result of the conditional branch instruction has some kind of trend. For example, if the previous execution result of the conditional branch instruction indicates the branch taken, the next execution result of the conditional branch instruction often indicates the branch taken as well.

Section 7.2.1.2 of e200z6 PowerPC™ Core Reference Manual (searched on Jul. 31, 2007, URL: http://www.freescale.com/files/32bit/doc/ref_manual/e200z6RMA D.pdf) discloses a technique of registering the execution result of the conditional branch instruction in a BTB (Branch Target Buffer) as prediction information and performing the branch prediction by referring to the BTB.

More specifically, the branch prediction device registers the execution result in the BTB as the prediction information only when the execution result of the conditional branch instruction indicates the branch taken. Further, the BTB stores as the prediction information four values of high probability of branching (Strongly Taken: hereinafter referred to as ST), low probability of branching (Weakly Taken: hereinafter referred to as WT), low probability of not branching (Weakly Not Taken: hereinafter referred to as WN), and high probability of not branching (Strongly Not Taken: hereinafter referred to as SN). When the execution result of the conditional branch instruction indicates the branch taken, the prediction information stored in the BTB transits from SN to WN, WN to WT, and WT to ST, as shown in FIG. 6. Further, when the execution result of the conditional branch instruction indicates branch not taken, the prediction information stored in the BTB transits from ST to WT, WT to WN, and WN to SN. When the prediction information is ST or WT, the branch prediction device predicts branching. On the other hand, when the prediction information is SN or WN, the branch prediction device predicts no branching. When the conditional branch instruction is not executed and the prediction information is not registered, the branch prediction device predicts no branching.

The following Table 1 shows the number of execution cycles when the branch prediction is performed and is not performed. Table 1 shows the number of execution cycles when a loop having a loop count set to five is executed for two cycles. In Table 1, T indicates branch taken (Taken), NT indicates branch not taken (Not Taken), M indicates prediction miss (Miss), and H indicates prediction hit (Hit).

In Table 1, in a case where the branch prediction is not performed, the number of execution cycles when the execution result of the conditional branch instruction is branch taken is 5, and the number of execution cycles when the execution result of the conditional branch instruction is branch not taken is 1. The total number of cycles is 42.

On the other hand, in a case where the branch prediction is performed, the number of execution cycles when the prediction makes a hit is 1; the number of execution cycles when the prediction makes a miss is 5. The total number of cycles is 22. Accordingly, by performing the branch prediction, the number of execution cycles decreases and the processing speed of the microprocessor is improved.

TABLE 1

| | | Loop cycle | | | | | | | | | | |
|---|---|---|---|---|---|---|---|---|---|---|---|---|
| | | 1 | | | | | 2 | | | | | |
| | | Loop count | | | | | | | | | | |
| | | 1 | 2 | 3 | 4 | 5 | 1 | 2 | 3 | 4 | 5 | Total |
| Branch | | T | T | T | T | NT | T | T | T | T | NT | |
| Prediction | | | WT | ST | ST | ST | WT | ST | ST | ST | ST | |
| Result | | M | H | H | H | M | H | H | H | H | M | |
| Cycle | No | 5 | 5 | 5 | 5 | 1 | 5 | 5 | 5 | 5 | 1 | 42 |
| | prediction | | | | | | | | | | | |
| | After | 5 | 1 | 1 | 1 | 5 | 1 | 1 | 1 | 1 | 5 | 22 |
| | prediction | | | | | | | | | | | |

Further, Japanese Unexamined Patent Application Publication No. 2002-182906 (Okura) discloses a technique of storing a conditional branch instruction and past branch history, providing a deviation counter detecting branch deviation from the branch history, and performing the branch prediction from the branch deviation, thereby enhancing the accuracy of the branch prediction.

However, in the e200z6 PowerPC™ Core Reference Manual, when a new conditional branch instruction is executed, the execution result is initially registered in the BTB as the prediction information only when the execution result of the conditional branch instruction indicates the branch taken. Accordingly, the number of execution cycles may be increased by performing the branch prediction depending on the programs. FIG. 5 shows a program example in which the number of execution cycles increases by performing the branch prediction. As shown in FIG. 5, the program has a loop structure in which four instructions of I1, I2, I3, and I4 are included, and the four instructions of I1 to I4 are repeatedly executed for a plurality of cycles. The loop includes a conditional branch instruction I3. Further, in FIG. 5, “×4” denoted by a symbol N1 does not indicate a program description but indicates that the loop of I1 to I4 is repeated for four times. Namely, the execution result of the conditional branch instruction I3 indicates not taken when the loop count is less than four, and indicates taken when the loop count is set to five. Accordingly, the number of times the loop is to be executed (loop count) shown in FIG. 5 is five. The following Table 2 shows the number of execution cycles when the loop shown in FIG. 5 is executed for two cycles. Table 2 shows the number of execution cycles when the branch prediction is performed and is not performed. As shown in Table 2, the execution results of the conditional branch instruction are NT, NT, NT, NT, and T, which means the execution result T is registered as the prediction information for the first time after the fifth execution of the loop in the first cycle. Since the prediction information is T although the first execution result of the loop in the second cycle is NT, the prediction makes a miss. Accordingly, the number of execution cycles in performing the branch prediction is larger than that in a case where the branch prediction is not performed.

TABLE 2

| | | Loop cycle | | | | | | | | | | |
|---|---|---|---|---|---|---|---|---|---|---|---|---|
| | | 1 | | | | | 2 | | | | | |
| | | Loop count | | | | | | | | | | |
| | | 1 | 2 | 3 | 4 | 5 | 1 | 2 | 3 | 4 | 5 | Total |
| Branch | | NT | NT | NT | NT | T | NT | NT | NT | NT | T | |
| Prediction | | | | | | | WT | WN | SN | SN | SN | |
| Result | | | | | | | M | H | H | H | M | |
| Cycle | No | 1 | 1 | 1 | 1 | 5 | 1 | 1 | 1 | 1 | 5 | 18 |
| | prediction | | | | | | | | | | | |
| | After | 1 | 1 | 1 | 1 | 5 | 5 | 1 | 1 | 1 | 5 | 22 |
| | prediction | | | | | | | | | | | |

Further, in Okura, the branch deviation can be detected only after the same conditional branch instruction is executed for a plurality of times. Accordingly, when the number of executions of the conditional branch instruction is small, the accurate branch prediction cannot be performed. Further, the circuit configuration is complicated since the deviation counter or the like is provided.

### SUMMARY

A branch prediction device according to a first aspect of the present invention predicts a branching probability of a branch condition of a conditional branch instruction read out from an instruction memory storing an instruction being satisfied. A branch prediction entry part included in the device stores prediction information as to whether or not the branch condition of the conditional branch instruction is satisfied. An entry update part included in the device predicts the branching probability when the conditional branch instruction is executed next time based on a branch direction and updates the prediction information when the branch condition is satisfied by executing the conditional branch instruction.

A microprocessor according to a second aspect of the present invention includes a branch prediction device predicting a branching probability of a branch condition of a conditional branch instruction read out from an instruction memory storing an instruction being satisfied. A branch prediction entry part included in the branch prediction device stores prediction information as to whether or not the branch condition of the conditional branch instruction is satisfied. An entry update part included in the branch prediction device predicts the branching probability when the conditional branch instruction is executed next time based on a branch direction and updates the prediction information when the branch condition is satisfied by executing the conditional branch instruction.

A branch prediction method according to a third aspect of the present invention is a branch prediction method predicting a branching probability of a branch condition of a conditional branch instruction read out from an instruction memory storing an instruction being satisfied. This method includes storing prediction information in a branch prediction entry part as to whether or not the branch condition of the conditional branch instruction is satisfied, and predicting the branching probability when the conditional branch instruction is executed next time based on a branch direction and updating the prediction information when the branch condition is satisfied by executing the conditional branch instruction.

In the first to third aspects above, the branching probability when the conditional branch instruction is executed next time is predicted based on the branch direction. Accordingly, it is possible to perform the branch prediction more accurately compared with the related art in which the next branching probability of the conditional branch instruction is predicted simply based on the previous execution result of the conditional branch instruction.

Further, since there is no need to provide a special counter or the like, the circuit configuration can be made simpler. It is possible to perform the branch prediction with accurate even when the number of executions of the conditional branch instruction is small.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing a schematic configuration of a microprocessor according to an embodiment of the present invention;

FIG. 2 shows an example of a branch prediction entry part according to the embodiment of the present invention;

FIG. 3 is a flow chart explaining an example of an initial registration in a branch prediction device according to the embodiment of the present invention;

FIG. 4 is a flow chart explaining an initial registration in a branch prediction device according to a second comparative example;

FIG. 5 is a diagram explaining one example of a loop including a conditional branch instruction and is repeatedly executed for a plurality of cycles; and

FIG. 6 is a diagram explaining a transition of prediction information in a related art.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

The embodiment to which the present invention can be applied will now be described.

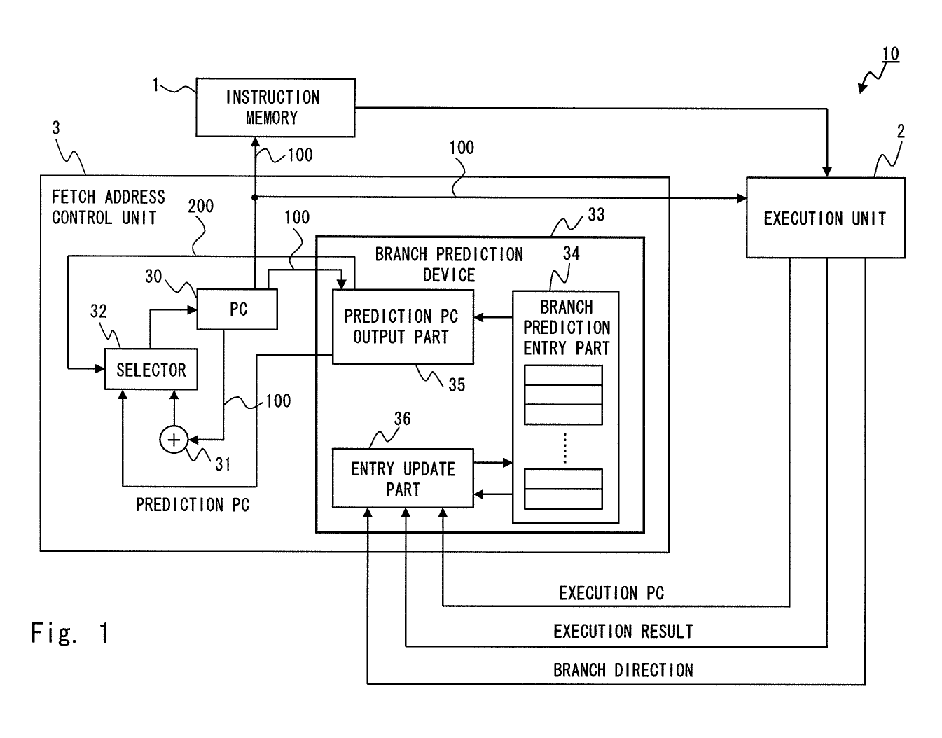

FIG. 1 shows a microprocessor 10 including a branch prediction device 33 according to the embodiment of the present invention. As shown in FIG. 1, the microprocessor 10 includes an instruction memory 1, an execution unit 2, a fetch address control unit 3 and so on.

The instruction memory 1 stores a plurality of instructions which are to be executed by the execution unit 2. Each instruction is assigned thereto an address for designating the instruction. The instruction according to the address can be designated by designating the address.

The execution unit 2 executes the instruction inputted from the instruction memory 1. The execution unit 2 includes a plurality of processing units (not shown). The plurality of processing units execute the instructions concurrently and in parallel with; therefore the execution unit 2 executes a plurality of instructions concurrently and in parallel (pipeline processing).

Further, the execution unit 2 inputs an execution PC, an execution result, and a branch direction to the fetch address control unit 3.

The execution PC is the address on the instruction memory 1 where the instruction to be executed is stored.

The branch direction is a direction of branching when the execution result indicates branch taken. More particularly, the branch direction includes plus (first direction) and minus (second direction). The branching in the plus direction means the branching into an address value increased from an address value of the instruction memory 1 storing the conditional branch instruction; the branching in the minus direction means the branching into an address value decreased from the address value of the instruction memory 1 storing the conditional branch instruction.

Further, the execution result is a result of executing the conditional branch instruction, and includes information as to whether or not the branch is taken, and a branch destination PC 342. The branch destination PC 342 is an address of an instruction that will be executed next when the result of executing the conditional branch instruction by the execution unit 2 indicates branch taken.

The fetch address control unit 3 includes a PC (program counter; address designation part) 30, an adder 31, a selector 32, and a branch prediction device 33.

The PC 30 is a register holding an address of the instruction that is to be executed next by the execution unit 2 on the instruction memory 1. The fetch address control unit 3 inputs the address held in the PC 30 (hereinafter referred to as held address 100) to the instruction memory 1. Then the instruction is read out based on the held address 100 in the instruction memory 1. Then the execution unit 2 fetches from the instruction memory 1 the instruction to be executed.

Further, the fetch address control unit 3 inputs the held address 100 held in the PC 30 into the execution unit 2.

Furthermore, the PC 30 inputs the held address 100 to the branch prediction device 33 and to the adder 31.

The adder 31 performs an adding processing on the held address 100 inputted from the PC 30 and inputs the adding result to the selector 32. The adding processing here means a process of incrementing the address.

The selector 32 selects one of a prediction PC inputted from the branch prediction device 33 and the address inputted from the adder 31 to output the selected one to the PC 30. The prediction PC here means an address of an instruction, which is predicted by the branch prediction device 33 as the instruction executed next by the execution unit 2, on the instruction memory 1.

The selector 32 receives from the branch prediction device 33 a taken/not-taken signal 200 representing whether or not the result of the branch prediction indicates the branch taken. For example, when the result of the branch prediction indicates the branch taken, the branch prediction device 33 inputs “1” to the selector 32 as the taken/not-taken signal 200. When the result of the branch prediction indicates the branch not taken, the branch prediction device 33 inputs “0” to the selector 32 as the taken/not-taken signal 200.

When the branch prediction device 33 does not perform the branch prediction and when a result of predicting a branching probability in which a branch condition of the conditional branch instruction is satisfied indicates no satisfaction, the selector 32 selects the address inputted from the adder 31.

Further, when the result of predicting the branching probability in which the branch condition of the conditional branch instruction is satisfied indicates the satisfaction, the selector 32 selects the prediction PC inputted from the branch prediction device 33.

The branch prediction device 33 includes a branch prediction entry part 34 (storing means), a prediction PC output part 35, and an entry update part 36.

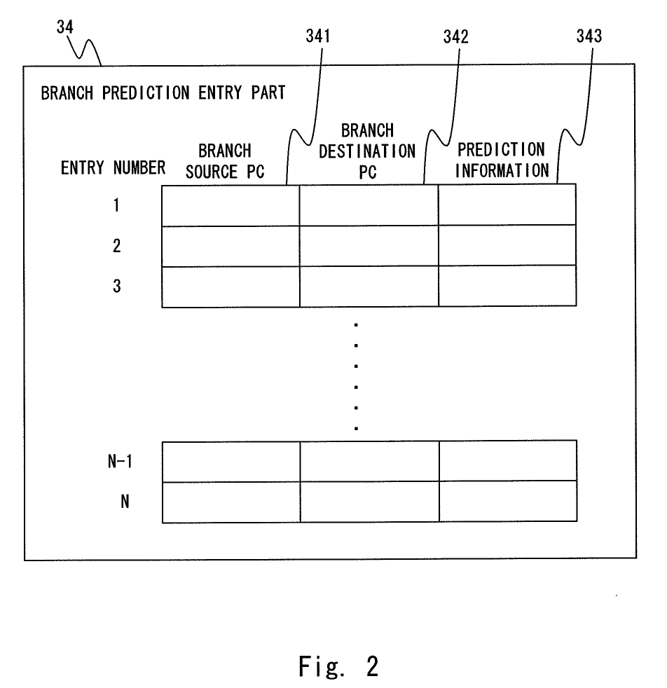

The branch prediction entry part 34 stores prediction information 343 obtained by performing the branch prediction by the branch prediction device 33. More specifically, the branch prediction entry part 34 stores an entry number, a branch source PC 341, a branch destination PC 342, and the prediction information 343 as being associated with one another as shown in FIG. 2.

More specifically, the branch prediction entry part 34 is a storing part storing the branch source PC 341, the branch destination PC 342, and the prediction information 343 as one set. Further, the branch prediction entry part 34 is formed by registers in one embodiment. The branch prediction entry part 34 is formed by N (N is an integer) registers in order to store the set of the branch source PC 341, the branch destination PC 342, and the prediction information 343. Further, entry numbers 1 to N are given to the registers respectively. The register is designated by designating the entry number so as to perform reading/writing from/to the register. When more sets of information are stored in the branch prediction entry part 34, the branch prediction entry part 34 may be formed by a memory, for example. In this case, the designation may be performed by a memory address in place of the entry number.

The branch source PC 341 is the address of the conditional branch instruction, on which the branch prediction device 33 performs the branch prediction, on the instruction memory 1. More particularly, the branch source PC 341 is the execution PC inputted from the execution unit 2.

The branch destination PC 342 is an address of a branch destination instruction of the conditional branch instruction at the branch source PC 341.

The prediction information 343 is the information predicted by the branch prediction device 33 as to whether or not the execution result of the conditional branch instruction indicates the branch taken. More specifically, the prediction information 343 is stored in the branch prediction entry part 34 based on the execution result and the branch direction inputted from the execution unit 2.

The prediction PC output part 35 inputs the branch destination PC 342 to the selector 32 as the prediction PC when the execution result of the conditional branch instruction is predicted as the branch taken by the branch prediction device 33.

The prediction PC output part 35 inputs the taken/not-taken signal 200 representing that the result of the branch prediction indicates the branch taken to the selector 32 when the execution result of the conditional branch instruction is predicted as the branch taken by the branch prediction device 33.

Further, the prediction PC output part 35 inputs the taken/not-taken signal 200 representing that the result of the branch prediction indicates the branch not taken to the selector 32 when the execution result of the conditional branch instruction is predicted as the branch not taken by the branch prediction device 33.

More specifically, the prediction PC output part 35 determines whether or not the held address 100 held in the PC 30 is stored in the branch prediction entry part 34 as the branch source PC 341. Further, when it is determined that the held address 100 held in the PC 30 is stored in the branch prediction entry part 34 as the branch source PC 341, the prediction PC output part 35 determines whether or not the prediction information 343 corresponding to the branch source PC 341 indicates the branch taken. When it is determined that the prediction information 343 corresponding to the branch source PC 341 indicates the branch taken, the prediction PC output part 35 inputs the branch destination PC 342 corresponding to the branch source PC 341 to the selector 32 as the prediction PC. Further, when it is determined that the prediction information 343 corresponding to the branch source PC 341 indicates the branch taken, the prediction PC output part 35 inputs the taken/not-taken signal 200 (“1”, for example) representing that the result of the branch prediction indicates the branch taken to the selector 32.

Further, when it is determined that the held address 100 held in the PC 30 is stored in the branch prediction entry part 34 as the branch source PC and that the prediction information 343 corresponding to the branch source PC 341 indicates the branch not taken, the prediction PC output part 35 inputs the taken/not-taken signal 200 (“0”, for example) representing that the result of the branch prediction indicates the branch not taken to the selector 32.

The entry update part 36 updates the branch prediction entry part 34 based on the execution PC, the execution result, and the branch direction inputted from the execution unit 2.

Further, when a new conditional branch instruction is executed by the execution unit 2, the entry update part 36 performs the initial registration in the branch prediction entry part 34 based on the execution PC, the execution result, and the branch direction inputted from the execution unit 2.

The execution PC here means the address of the conditional branch instruction executed by the execution unit 2 on the instruction memory 1. The execution PC is registered in the branch prediction entry part 34 as the branch source PC by the entry update part 36.

Further, the execution result includes the information as to whether or not the branch is taken, and the information of the branch destination PC 342. The branch destination PC 342 is the address of the instruction that is to be executed next on the instruction memory 1 when the result of executing the conditional branch instruction by the execution unit 2 indicates the branch taken.

More specifically, the entry update part 36 determines whether or not the execution PC inputted from the execution unit 2 is stored in the branch prediction entry part 34 as the branch source PC 341.

When it is determined that the execution PC is not stored in the branch prediction entry part 34 as the branch source PC 341, the entry update part 36 determines whether or not the execution result indicates the branch taken.

When the execution result indicates the branch not taken, the entry update part 36 does not perform the initial registration in the branch prediction entry part 34.

When the execution result indicates the branch taken, the entry update part 36 performs the initial registration in the branch prediction entry part 34. More specifically, the entry update part 36 first determines whether or not the branch direction is the plus.

When the branch direction is the plus, the entry update part 36 stores the prediction information 343 indicating the branch not taken in the branch prediction entry part 34 as being associated with the execution PC. More specifically, when the branch direction is the plus, the entry update part 36 stores the execution PC in the branch prediction entry part 34 as the branch source PC 341. Further, the entry update part 36 stores the prediction information 343 indicating the branch not taken in the branch prediction entry part 34. Further, the entry update part 36 stores the branch destination PC 342 in the branch prediction entry part 34 based on the execution result.

When the branch direction is the minus, the entry update part 36 stores the prediction information 343 indicating the branch taken in the branch prediction entry part 34 as being associated with the execution PC. More specifically, when the branch direction is the minus, the entry update part 36 stores the execution PC in the branch prediction entry part 34 as the branch source PC 341. Further, the entry update part 36 stores the prediction information 343 indicating the branch taken in the branch prediction entry part 34. Further, the entry update part 36 stores the branch destination PC 342 in the branch prediction entry part 34 based on the execution result.

On the other hand, when it is determined that the execution PC is stored in the branch prediction entry part 34 as the branch source PC 341, the entry update part 36 updates the branch prediction entry part 34.

The entry update part 36 first determines whether or not the execution result indicates the branch taken. When the execution result indicates the branch taken, the entry update part 36 determines whether or not the branch direction is the plus.

When the branch direction is the plus, the entry update part 36 stores the prediction information 343 indicating the branch not taken in the branch prediction entry part 34. Thus, the branch prediction entry part 34 is updated. Note that since the branch destination PC 342 is stored in the branch prediction entry part 34 in the initial registration, the entry update part 36 does not perform re-registration of the branch destination PC 342 in the branch prediction entry part 34 in updating.

Further, when the branch direction is the minus, the entry update part 36 stores the prediction information 343 indicating the branch taken in the branch prediction entry part 34. Thus, the branch prediction entry part 34 is updated.

Further, when the execution result indicates the branch not taken, the entry update part 36 stores the prediction information 343 indicating the branch not taken in the branch prediction entry part 34. Thus, the branch prediction entry part 34 is updated.

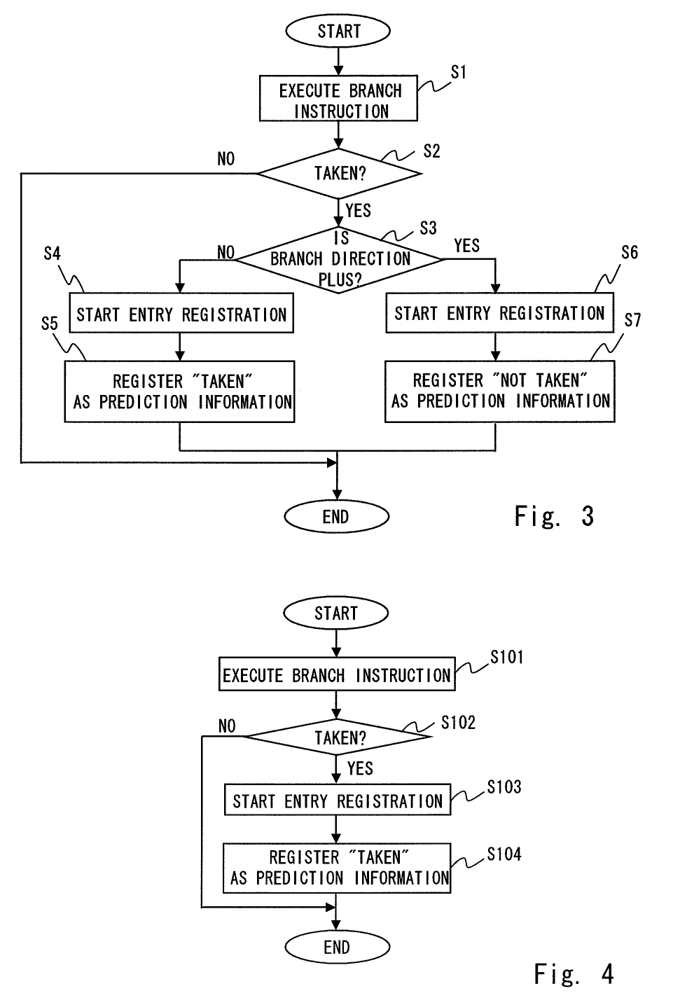

Now, the initial registration in the branch prediction entry part 34 of the branch prediction device 33 according to the present invention will be described with reference to a flow chart shown in FIG. 3.

First, the conditional branch instruction inputted from the instruction memory 1 is executed by the execution unit 2 (step S1).

Next, the entry update part 36 determines whether or not the execution result inputted from the execution unit 2 indicates the branch taken (step S2).

When the entry update part 36 determines that the execution result indicates the branch not taken at step S2 (step S2: No), the branch prediction device 33 terminates the processing without performing the initial registration.

When it is determined that the execution result indicates the branch taken at step S2 (step S2: Yes), the entry update part 36 determines whether or not the branch direction is the plus (step S3).

When it is determined that the branch direction is the minus at step S3 (step S3: No), the entry update part 36 starts the registration in the branch prediction entry part 34 (step S4). More specifically, the entry update part 36 stores the execution PC inputted from the execution unit 2 in the branch prediction entry part 34 as the branch source PC 341.

Next, the entry update part 36 stores the prediction information 343 indicating the branch taken in the branch prediction entry part 34 (step S5). Further, the entry update part 36 stores the address of the branch destination instruction on the instruction memory 1 in the branch prediction entry part 34 as the branch destination PC 342.

When it is determined that the branch direction is the plus at step S3 (step S3: Yes), the entry update part 36 starts the registration in the branch prediction entry part 34 (step S6). More specifically, the entry update part 36 stores the execution PC inputted from the execution unit 2 in the branch prediction entry part 34 as the branch source PC 341.

Next, the entry update part 36 stores the prediction information 343 indicating the branch not taken in the branch prediction entry part 34 (step S7). Further, the entry update part 36 stores the address of the branch destination instruction on the instruction memory 1 in the branch prediction entry part 34 as the branch destination PC 342.

In the branch prediction device 33 and the microprocessor 10 according to the embodiment of the present invention described above, there is included the branch prediction entry part 34 and the entry update part 36. The branch prediction entry part 34 stores the prediction information 343 as to whether or not the branch condition of the conditional branch instruction is satisfied. The entry update part 36 predicts the branching probability when the conditional branch instruction is executed next time based on the branch direction and updates the prediction information 343 upon satisfaction of the branch condition by executing the conditional branch instruction.

More specifically, when the execution result of the conditional branch instruction indicates the branch taken, the prediction information 343 indicating the branch not taken is stored in the branch prediction entry part 34 if the branch direction is the plus, and the prediction information 343 indicating the branch taken is stored in the branch prediction entry part 34 if the branch direction is the minus.

Thus, the branch prediction device 33, the branch prediction method, and the microprocessor 10 according to the embodiment of the present invention predict the branching probability when the conditional branch instruction is executed next time based on the branch direction. Accordingly, it is possible to perform the branch prediction more accurately compared with the related art in which the next branching probability of the conditional branch instruction is predicted simply based on the previous execution result of the conditional branch instruction. Hence, in the microprocessor 10 including the branch prediction device 33 according to the embodiment of the present invention, it is possible to decrease the number of execution cycles and to enhance the processing speed.

Further, since there is no need to provide a special counter or the like, the circuit configuration can be made simpler.

Moreover, the branch prediction can be performed with accurate even when the number of executions of the conditional branch instruction is small. When the execution result of the conditional branch instruction indicates the branch taken, the branching probability in which the branch condition of the conditional branch instruction is satisfied next time is predicted based on the branch direction. Since the branching probability is predicted based on the branch direction, it is possible to perform the branch prediction more accurately than the related art in which the next branching probability of the conditional branch instruction is predicted simply based on the previous execution result of the conditional branch instruction.

Further, in the branch prediction device 33, when the branch condition of the conditional branch instruction is not satisfied, the prediction information is updated to the prediction information 343 indicating no satisfaction if the prediction information 343 of the conditional branch instruction is stored in the branch prediction entry part 34.

Accordingly, the execution result of the conditional branch instruction can be reflected in the prediction information 343 of the branch prediction entry part 34.

Furthermore, the branch prediction is performed in the branch prediction device 33 according to the plus or the minus of the branch direction so as to be able to accurately predict even for the conditional branch instruction included in the loop repeatedly executed for a plurality of cycles. More specifically, the execution result of the conditional branch instruction in the loop repeatedly executed for the plurality of cycles may indicate the branch taken only for the last loop count and the branch direction may be the plus. In this case, the branch prediction device 33 sets the prediction information 343 of the conditional branch instruction to the branch not taken reflecting that the branch direction is the plus. Accordingly, it is possible to accurately predict that the execution result of the first loop count in the next cycle becomes the branch not taken.

Note that the prediction information 343 may be formed by two-bit data. Then the branch prediction entry part 34 may store as the prediction information 343 four values of 11 (high probability of branching (Strongly Taken)), 10 (low probability of branching (Weakly Taken)), 01 (low probability of not branching (Weakly Not Taken)), 00 (high probability of not branching (Strongly Not Taken)). In this case, the branch prediction device 33 determines that the branch is taken when the prediction information 343 is 11 or 10, and determines that the branch is not taken when the prediction information 343 is 01 or 00.

### FIRST EXAMPLE

Next, the first example of the present invention will be described comparing first example with first and second comparative examples. The microprocessor 10 according to the first example includes the branch prediction device 33 according to the embodiment of the present invention.

By contrast, in the first comparative example, the branch prediction device is not included in the microprocessor. Further, in the second comparative example, the related branch prediction device is included in the microprocessor.

In the related branch prediction device, when a new conditional branch instruction is executed, the execution result of the conditional branch instruction is initially registered in the branch prediction entry part as the prediction information only when the execution result indicates the branch taken. The initial registration in the branch prediction entry part of the branch prediction device according to the second comparative example will be described with reference to a flow chart shown in FIG. 4.

First, the conditional branch instruction inputted from the instruction memory is executed by the execution unit of the microprocessor according to the second comparative example (step S101).

Then the branch prediction device determines whether or not the execution result input from the execution unit indicates the branch taken (step S102).

When it is determined that the execution result indicates the branch not taken at step S102 (step S102: No), the branch prediction device terminates the processing without performing the initial registration.

When it is determined that the execution result indicates the branch taken at step S102 (step S102: Yes), the branch prediction device starts the registration in the branch prediction entry part (step S103).

Next, the branch prediction device stores the prediction information indicating the branch taken in the branch prediction entry part (step S104).

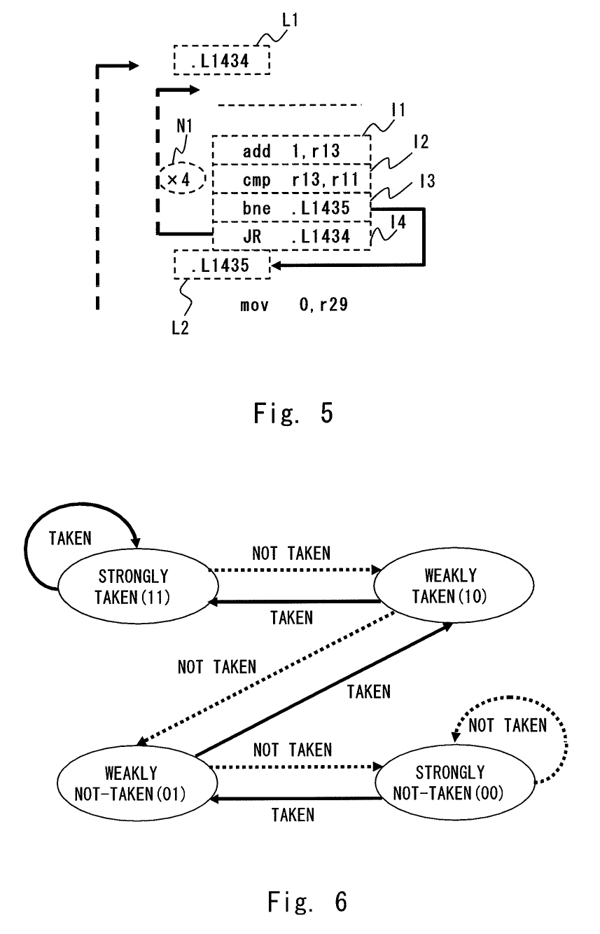

Next, the number of execution cycles required in each of the first comparative example, the second comparative example, and the first example in executing the program shown in FIG. 5 is compared.

As shown in FIG. 5, the program has the loop structure in which four instructions of I1, I2, I3, and I4 are included, and the instructions of I1 to I4 are repeatedly executed for a plurality of cycles. The loop includes the conditional branch instruction I3. Further, in FIG. 5, “×4” denoted by a symbol N1 does not indicate a program description but indicates that the loop of I1 to I4 is repeated for four times. Namely, the execution result of the conditional branch instruction I3 indicates not taken when the loop count is less than four, and indicates taken when the loop count is set to five. Accordingly, the number of times the loop is to be executed (loop count) shown in FIG. 5 is five.

More specifically, in FIG. 5, L1 is a label indicating the branching destination of I4 which is a non-conditional branch instruction. I1 indicates an adding instruction. I2 indicates a comparing instruction. I3 indicates the conditional branch instruction. It is determined in the conditional branch instruction I3 whether or not the branching is taken based on a result of performing the comparison by the comparing instruction I2. I4 is the non-conditional branch instruction, which indicates the branching into L1. L2 is a branching destination label of the conditional branch instruction I3. When the loop count is set to five, the execution result of the conditional branch instruction I3 indicates the branch taken, and branching is executed into the instruction out of the loop (instruction corresponding to the label L2).

The numbers of execution cycles required in the first comparative example, the second comparative example, and the first example when the loop having the loop count set to five shown in FIG. 5 is executed for two cycles are shown in the following Table 3, Table 4, and Table 5, respectively. In Tables 3, 4, and 5, T indicates branch taken (Taken), and NT indicates branch not taken (Not Taken). Further, in Tables 4 and 5, M indicates prediction miss (Miss), and H indicates prediction hit (Hit). As shown in Tables 3, 4, and 5, when the loop having the loop count set to five shown in FIG. 5 is executed for two cycles, the execution results of the conditional branch instruction I3 are NT, NT, NT, NT, T(+), NT, NT, NT, NT, and T(+). The symbol of (+) in T(+) indicates that the branch direction is the plus.

TABLE 3

| | Loop count | | | | | | | | | | |
|---|---|---|---|---|---|---|---|---|---|---|---|
| | 1 | 2 | 3 | 4 | 5 | 1 | 2 | 3 | 4 | 5 | Total |
| Instruction | NT | NT | NT | NT | T(+) | NT | NT | NT | NT | T(+) | |
| Cycle | 1 | 1 | 1 | 1 | 5 | 1 | 1 | 1 | 1 | 5 | 18 |

TABLE 4

| | Loop count | | | | | | | | | | |
|---|---|---|---|---|---|---|---|---|---|---|---|
| | 1 | 2 | 3 | 4 | 5 | 1 | 2 | 3 | 4 | 5 | Total |
| Instruction | NT | NT | NT | NT | T(+) | NT | NT | NT | NT | T(+) | |
| Prediction | — | — | — | — | Regis- | T | NT | NT | NT | NT | |
| | | | | | tration | | | | | | |
| Result | — | — | — | — | — | M | H | H | H | M | |
| Cycle | 1 | 1 | 1 | 1 | 5 | 5 | 1 | 1 | 1 | 5 | 22 |

TABLE 5

| | Loop count | | | | | | | | | | |
|---|---|---|---|---|---|---|---|---|---|---|---|
| | 1 | 2 | 3 | 4 | 5 | 1 | 2 | 3 | 4 | 5 | Total |
| Instruction | NT | NT | NT | NT | T(+) | NT | NT | NT | NT | T(+) | |
| Prediction | — | — | — | — | Regis- | NT | NT | NT | NT | NT | |
| | | | | | tration | | | | | | |
| Result | — | — | — | — | — | H | H | H | H | M | |
| Cycle | 1 | 1 | 1 | 1 | 5 | 1 | 1 | 1 | 1 | 5 | 18 |

As shown in Table 3, in the first comparative example in which the branch prediction is not performed, the number of execution cycles when the execution result of the conditional branch instruction I3 indicates the branch not taken is 1, and the number of execution cycles when the execution result of the conditional branch instruction I3 indicates the branch taken is 5. The total number of cycles is 18.

On the other hand, as shown in Table 4, in the second comparative example performing the related branch prediction, the execution result of the conditional branch instruction I3 is initially registered in the branch prediction entry part as the prediction information only when the execution result indicates the branch taken in the loop of the first cycle. In other words, the execution result T is registered as the prediction information for the first time after the fifth execution of the loop in the first cycle. Since the prediction information is T although the first execution result of the loop in the second cycle is NT, the prediction makes a miss. As shown in Table 4, the number of execution cycles is 1 when the prediction makes a hit, while the number of execution cycles is 5 when the prediction makes a miss. Then the total number of cycles is 22, which means the number of execution cycles increases compared with the first comparative example in which the branch prediction is not performed.

By contrast, in the first example performing the branch prediction according to the present invention, the prediction information 343 based on the branch direction is registered for the first time after the fifth execution of the loop in the first cycle. More specifically, since the branch direction in the fifth execution of the loop in the first cycle is the plus, NT indicating the branch not taken is registered in the branch prediction entry part 34 as the prediction information 343. Since the first execution result of the loop in the second cycle is NT, the prediction makes a hit. Therefore, the number of execution cycles in the first execution of the loop in the second cycle is 1. Then the total number of cycles is 18, which is the same as in the first comparative example in which the branch prediction is not performed.

As stated above, according to the first example, the number of execution cycles does not increase even with the conditional branch instruction included in the loop repeatedly executed for a plurality of cycles as shown in FIG. 5. The conditional branch instruction included in the loop repeatedly executed for the plurality of cycles as shown in FIG. 5 is often seen in the program. Accordingly, in the first example according to the present invention, the branch prediction of the conditional branch instruction included in the loop shown in FIG. 5 is accurately performed so that the number of execution cycles can be greatly decreased. Namely, it is possible to enhance the processing speed of the microprocessor 10 according to the first example of the present invention.

It is apparent that the present invention is not limited to the above embodiments, but may be modified and changed without departing from the scope and spirit of the invention.

What is claimed is:

1. A branch prediction device, comprising:
a branch prediction entry part storing prediction information as to whether or not a branch condition of a conditional branch instruction read out from an instruction memory storing an instruction is satisfied; and
an entry update part predicting a branching probability of the branch condition being satisfied when the conditional branch instruction is executed next time based on a branch direction and updating the prediction information when the branch condition is satisfied by executing the conditional branch instruction.

2. The branch prediction device according to claim 1, wherein the branch prediction entry part stores an address of the conditional branch instruction stored in the instruction memory, the prediction information as to whether or not the branch condition of the conditional branch instruction is satisfied, and an address of a branch destination instruction when the branch condition of the conditional branch instruction is satisfied as being associated with one another.

3. The branch prediction device according to claim 2, wherein
the instruction memory stores a plurality of the conditional branch instructions, and
the branch prediction entry part stores the address of the conditional branch instruction, the prediction information, and the address of the branch destination instruction for each of the conditional branch instructions.

4. The branch prediction device according to claim 2, wherein
the entry update part receives the address of the conditional branch instruction, an execution result of the conditional branch instruction, and the branch direction when the conditional branch instruction is executed,
the execution result includes the information as to whether or not the branch condition of the conditional branch instruction is satisfied, and the address of the branch destination instruction when the branch condition is satisfied, and
the entry update part outputs the address of the conditional branch instruction, the prediction information of the conditional branch instruction, and the address of the branch destination instruction to the branch prediction entry part based on the address of the conditional branch instruction, the execution result, and the branch direction which are received.

5. The branch prediction device according to claim 2, further comprising a prediction PC output part outputting the address of the branch destination instruction corresponding to the prediction information to an address designation part designating the address of the instruction memory when the prediction information stored in the branch prediction entry part indicates the satisfaction.

6. The branch prediction device according to claim 1, wherein the entry update part updates the prediction information to prediction information indicating no satisfaction if the prediction information of the conditional branch instruction is stored in the branch prediction entry part when the branch condition is not satisfied as a result of the conditional branch instruction being executed.

7. The branch prediction device according to claim 1, wherein the branch prediction device predicts that the branch condition of the conditional branch instruction is not satisfied next time if the branch direction is a first direction, and predicts that the branch condition of the conditional branch instruction is satisfied next time if the branch direction is a second direction.

8. The branch prediction device according to claim 7, wherein
the first direction is a branch direction in which an address of a branch destination instruction when the branch condition of the conditional branch instruction is satisfied increases from an address of the conditional branch instruction, and
the second direction is a branch direction in which the address of the branch destination instruction when the branch condition of the conditional branch instruction is satisfied decreases from the address of the conditional branch instruction.

9. A microprocessor, comprising:
an instruction memory storing an instruction; and
a branch prediction device including a branch prediction entry part and an entry update part, the branch prediction entry part storing prediction information as to whether or not a branch condition of a conditional branch instruction read out from the instruction memory is satisfied, and the entry update part predicting a branching probability of the branch condition being satisfied when the conditional branch instruction is executed next time based on a branch direction and updating the prediction information when the branch condition is satisfied by executing the conditional branch instruction.

10. The microprocessor according to claim 9, wherein
the instruction memory stores a plurality of the conditional branch instructions,
the branch prediction entry part stores an address of the conditional branch instruction, the prediction information, and an address of a branch destination instruction for each of the conditional branch instructions as being associated with one another,
the branch prediction device further comprises a prediction PC output part outputting the address of the branch destination instruction corresponding to the prediction information when the prediction information stored in the branch prediction entry part indicates the satisfaction, and
the microprocessor further comprises:
a fetch address control unit outputting the address of the branch destination instruction as an address of a instruction to be executed when the prediction information indicates the satisfaction, and
an execution unit reading out from the instruction memory the instruction to be executed based on the address of the branch destination instruction inputted from the fetch address control unit.

11. The microprocessor according to claim 9, wherein the branch prediction device predicts that the branch condition of the conditional branch instruction is not satisfied next time if the branch direction is a first direction, and predicts that the branch condition of the conditional branch instruction is satisfied next time if the branch direction is a second direction.

12. The microprocessor according to claim 11, wherein
the first direction is a branch direction in which an address of a branch destination instruction when the branch condition of the conditional branch instruction is satisfied increases from an address of the conditional branch instruction, and
the second direction is a branch direction in which the address of the branch destination instruction when the branch condition of the conditional branch instruction is satisfied decreases from the address of the conditional branch instruction.

13. A branch prediction method, comprising:
storing in a branch prediction entry part prediction information as to whether or not a branch condition of a conditional branch instruction read out from an instruction memory storing an instruction is satisfied; and
predicting a branching probability of the branch condition being satisfied when the conditional branch instruction is executed next time based on a branch direction and updating the prediction information when the branch condition is satisfied by executing the conditional branch instruction.

14. The branch prediction method according to claim 13, wherein the branch prediction entry part stores an address of the conditional branch instruction stored in the instruction memory, the prediction information as to whether or not the branch condition of the conditional branch instruction is satisfied, and an address of a branch destination instruction when the branch condition of the conditional branch instruction is satisfied as being associated with one another.

15. The branch prediction method according to claim 14, wherein
the instruction memory stores a plurality of the conditional branch instructions, and
the branch prediction entry part stores the address of the conditional branch instruction, the prediction information, and the address of the branch destination instruction for each of the conditional branch instructions.

16. The branch prediction method according to claim 14, wherein
the address of the conditional branch instruction, an execution result of the conditional branch instruction, and the branch direction are inputted when the conditional branch instruction is executed,
the execution result includes the information as to whether or not the branch condition of the conditional branch instruction is satisfied, and the address of the branch destination instruction when the branch condition is satisfied, and
the address of the conditional branch instruction, the prediction information of the conditional branch instruction, and the address of the branch destination instruction are outputted to the branch prediction entry part based on the address of the conditional branch instruction, the execution result, and the branch direction which are inputted.

17. The branch prediction method according to claim 14, further comprising outputting the address of the branch destination instruction corresponding to the prediction information to an address designation part designating the address of the instruction memory when the prediction information stored in the branch prediction entry part indicates the satisfaction.

18. The branch prediction method according to claim 13, comprising updating the prediction information to prediction information indicating no satisfaction if the prediction information of the conditional branch instruction is stored in the branch prediction entry part when the branch condition is not satisfied as a result of the conditional branch instruction being executed.

19. The branch prediction method according to claim 13, wherein the branch condition of the conditional branch instruction is predicted as being not satisfied next time if the branch direction is a first direction, and is predicted as being satisfied next time if the branch direction is a second direction.

20. The branch prediction method according to claim 19, wherein
the first direction is a branch direction in which an address of a branch destination instruction when the branch condition of the conditional branch instruction is satisfied increases from an address of the conditional branch instruction, and
the second direction is a branch direction in which the address of the branch destination instruction when the branch condition of the conditional branch instruction is satisfied decreases from the address of the conditional branch instruction.
